(19) United States
(12) Patent Application Publication
(10) Pub. No.: US 2024/0376614 A1
(43) Pub. Date: Nov. 14, 2024

(54) ELECTROLYSER, BIPOLAR PLATE AND METHOD FOR PRODUCTION THEREOF

(71) Applicant: Robert Bosch GmbH, Stuttgart (DE)

(72) Inventor: Kai Weeber, Heimsheim (DE)

(21) Appl. No.: 18/564,811

(22) PCT Filed: May 5, 2022
(86) PCT No.: PCT/EP2022/062128

§ 371 Date: Jan. 11, 2024

(30) Foreign Application Priority Data
May 28, 2021 (DE) 10 2021 205 458.7

(51) Int. Cl. C25B 11/036; C25B 11/052; C25B 11/069

(52) U.S. Cl. CPC C25B 11/036; C25B 11/052; C25B 11/069

(57) ABSTRACT

The invention relates to a bipolar plate (20) comprising a plate (21) which comprises an electrically conductive plastics composite material and is structured on at least one side (22). The plate (21) is coated with a catalyst (23) on its structured side (22). The invention also relates to an electrolyser comprising at least one such a bipolar plate (20). The bipolar plate (20) is produced by providing a plate (21), which comprises an electrically conductive plastics composite material, heating the plate (21) to a first temperature, heating a catalyst (23) in powder form to a second temperature which is higher than the first temperature and applying the catalyst (23) to a structured side (22) of the plate (21).

### BACKGROUND

The present invention relates to a bipolar plate and a method for production of the bipolar plate. Furthermore, the present invention relates to an electrolyser comprising the bipolar plate.

Water electrolysers can be operated as alkaline electrolysers, which use aqueous potassium hydroxide solution as the electrolyte. Such alkaline electrolysers do not require precious metal catalysts. Instead, Raney nickel, for example, is used as a catalyst. This is applied to a metal grid as a porous structure. This metal grid also acts as a current transmitter. The bipolar plates of such alkaline electrolysers are usually made of steel. Due to the alkaline conditions, they are generally not subject to corrosion.

DE 10 2018 220 464 A1 describes a distributor structure for an electrolyser that acts as a bipolar plate. This is designed as an electrically conductive graphite/plastic compound. It comprises a channel structure on its surface to improve water drainage. This bipolar plate is corrosion-resistant and can therefore also be used under acidic conditions.

### SUMMARY

The bipolar plate, which is intended in particular for an electrolyser, comprises a plate which comprises an electrically conductive plastics composite material. It is preferably made of this plastics composite material. By electrically conductive, it is meant in particular that the plate exhibits an electrical conductivity of more than 10⁶ S/m at a temperature of 25° C. The plate is structured on at least one side. The structured side of the plate is coated with a catalyst.

This bipolar plate has numerous advantages, especially when used in an alkaline water electrolyser. By using the plastics composite material instead of a metal, the bipolar plate can be manufactured more cost-effectively. It can also be thermally welded to other components of the electrolyser so that insert seals can be dispensed with. Above all, however, this bipolar plate makes it possible to dispense with a metal grid with a porous surface structure as a catalyst carrier. Inserting such a metal grid into the electrolyser increases the ohmic resistance at the interface between the bipolar plate and the metal grid. This leads to a reduction in the efficiency of the electrolyser and thus to an increase in the hydrogen production costs. Due to the higher efficiency of the electrolyser when using this bipolar plate, which also serves as a carrier for the catalyst, the higher efficiency of the electrolyser reduces the power loss that has to be discharged from a stack in the electrolyser.

It is preferred that the plastics composite material contains graphite and/or at least one metal and at least one thermoplastic. The thermoplastic makes it possible to thermally fix the catalyst to the structured side of the plate without the use of additional adhesives. The graphite and/or metal provides the composite material with electrical conductivity in a cost-effective manner. To this end, its weight proportion in the plastics composite material is preferably in the range of 88% to 95% by weight. The thermoplastic is in particular polyphenylene sulfide (PPS) and/or polypropylene (PP).

The catalyst preferably comprises metal particles with a number-average particle size in the range from 10 μm to 30 μm. In particular, the metal particles comprise a porous surface structure. These metal particles are particularly preferred. In conjunction with the structured surface of the plate, this particle size of the metal particles makes it possible to provide a sufficiently high catalyst surface for water electrolysis, while at the same time ensuring that the catalyst layer is easy to produce. The number-average particle size can be determined in particular by means of sieve analysis in accordance with the DIN 66165 standard.

Even if it is conceivable in principle to provide a precious metal-containing catalyst in order to use the bipolar plate in a PEM (proton exchange membrane) electrolyser operated under acidic conditions or in a fuel cell, it is preferable for the catalyst to be Raney nickel. This makes it possible to use the bipolar plate in an alkaline electrolyser, which can dispense with large quantities of precious metals as catalyst material, as required in an acidic environment.

In the method for producing the bipolar plate, the plate is first provided, which comprises the electrically conductive plastics composite material and preferably consists of it. At least one side of the plate is structured. The plate is heated to a first temperature. In addition, a catalyst in powder form is heated to a second temperature. The second temperature is higher than the first temperature. The catalyst is applied to the structured side of the plate. Due to the higher temperature of the catalyst in powder form, individual catalyst particles partially melt into the surface of the structured side of the plate and in this way permanently bond with it.

In order to achieve this effect particularly efficiently, it is preferred that the first temperature corresponds to at least one Vicat softening temperature of a plastic of the plastics composite material. This already causes the plate to soften so that catalyst particles hitting the plate can easily penetrate it. However, the plate remains dimensionally stable. The second temperature preferably corresponds to at least one dimensional stability temperature of the plastic of the plastics composite material. As soon as such a hot catalyst particle has hit the surface of the plate and adheres there due to its softening, it transfers further heat to the plastics composite material so that it is no longer dimensionally stable at certain points, which leads to a permanent bond between the catalyst particle and the plate. The Vicat softening temperature can be determined in particular according to the ISO 306 standard at a heating rate of 50° C. and a force of 50 N, and the dimensional stability temperature can be determined in particular according to the ISO 75-1/-2 standard at a pressure of 0.45 MPa.

In one embodiment of the method, the catalyst is blown onto the structured side of the plate. In a similar way to a sandblasting method, the catalyst particles can be subjected to high kinetic energy in order to drill into the surface of the plate.

In another embodiment of the method, the catalyst particles can be applied to the plate by means of a decal process. For this purpose, the catalyst is first applied to a carrier film. The carrier film is heated to the second temperature together with the catalyst. The carrier film is then pressed onto the structured side of the plate, with the side of the carrier film containing the catalyst facing the plate. The pressure can be precisely controlled in order to press the catalyst particles sufficiently deep into the surface of the plate. Once the plate has cooled sufficiently to create a permanent bond between the catalyst and the plastics composite material, the carrier film is finally removed.

The thermoplasticity of the plastic in the plastics composite material makes it possible, in particular, to provide the plate by producing it from the plastics composite material by injection molding or embossing.

The electrolyser comprises at least one of the described bipolar plates. Preferably, it comprises only such bipolar plates. In particular, it is designed as a water electrolyser. It can be operated on an alkaline basis.

### BRIEF DESCRIPTION OF THE DRAWINGS

Exemplary embodiments of the invention are illustrated in the drawings and are explained in more detail in the following description.

FIG. 1 shows an exploded view of a stack in an electrolyser according to an exemplary embodiment of the invention.

FIG. 2 shows a cross-sectional view of a bipolar plate according to an exemplary embodiment of the invention.

FIG. 3 shows a flow chart of a method according to an exemplary embodiment of the invention.

FIG. 4 shows a flow chart of a method according to another exemplary embodiment of the invention.

### DETAILED DESCRIPTION

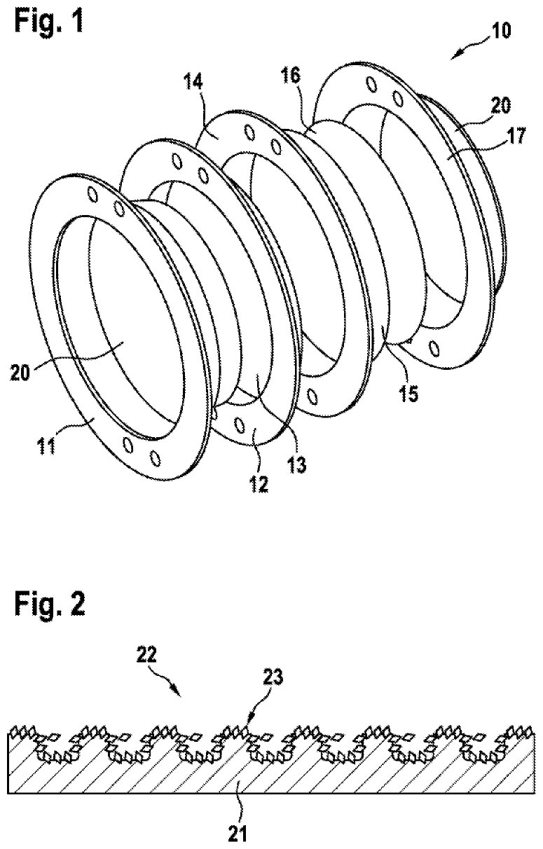

An electrolyser 10 according to an exemplary embodiment of the invention is designed as a water electrolyser. It is intended for alkaline electrolysis and uses potassium hydroxide as the electrolyte. During operation, it is filled with 30% potassium hydroxide solution. FIG. 1 shows the structure of one of its stacks. A cell frame 11 is followed by a first bipolar plate 20, which is thermoplastically welded to it. This is followed by a cathode cell frame 12, a cathode electrode 13, a membrane frame 14, a cell membrane 15, an anode electrode 16, an anode cell frame 17 and then the next bipolar plate 20.

One of the bipolar plates 20 is shown in FIG. 2. It comprises a plate 21, which in this exemplary embodiment is made of polypropylene containing graphite. One side 22 of plate 21 is structured. This structuring consists of channels. Particles of Raney nickel are applied to this side 22 as a catalyst 23. The catalyst comprises a number-average particle size of 20 μm. It is partially embedded in the plate 21, with the particles distributed at the bottom of the channels, on their walls and also outside the channels on the side 22.

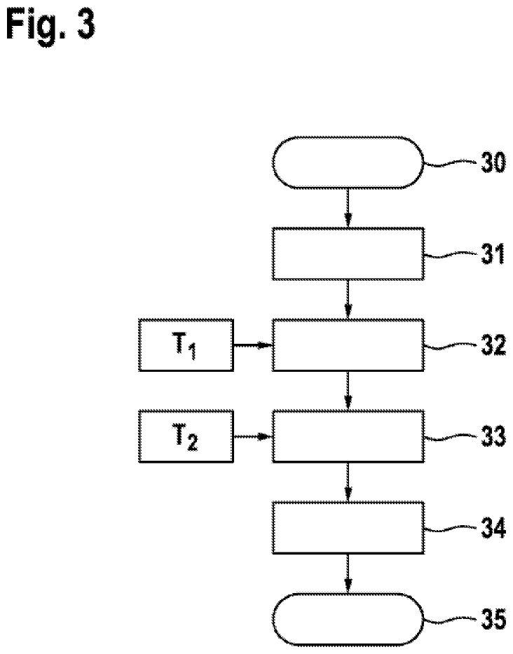

In a first exemplary embodiment of the method for producing the bipolar plate 20, as shown in FIG. 3, it is intended to provide 31 the plate 21 after the start 30 of the method. For this purpose, the plate 21 is produced by injection molding or embossing. This is followed by heating 32 of the plate 21 to a first temperature T₁. This first temperature T₁ is above the Vicat softening temperature of the polypropylene of 97° C. and below the dimensional stability temperature of the polypropylene of 133° C. In addition, the catalyst in powder form 23 is heated 33 to a second temperature T₂ of more than 133° C. Finally, the heated particles of the catalyst 23 are blown 34 from the structured side 22 onto the heated plate 21 by means of a powder coating device. The catalyst 23 adheres to the plate 21 and fuses with its surface. After the resulting bipolar plate 20 has cooled down to room temperature, the method is terminated 35. The catalyst 23 is now permanently fixed to the plate 21.

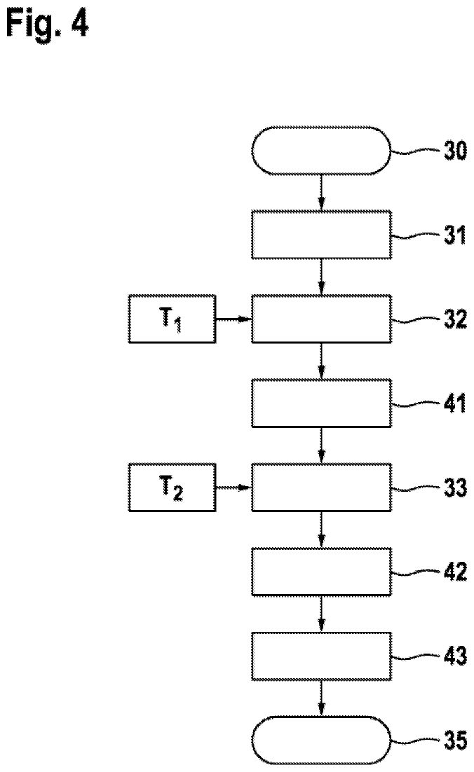

In a second exemplary embodiment of the method, shown in FIG. 4, steps 30 through 32 are carried out in the same manner as in the first exemplary embodiment of the method. However, the catalyst in powder form 23 is first applied to a decal carrier film 41 before it is subsequently heated 33 to the second temperature. The side of the carrier film with the heated catalyst 23 is then pressed 42 onto the structured side 22 of the plate 21. The particles of the catalyst 23 drill into the plate 21 and are partially melted into it. After the bipolar plate 20 has cooled down to room temperature, the carrier film is removed 43 and the method is then terminated 35. A bipolar plate 20 whose catalyst 23 is firmly fixed to the plate 21 can also be obtained in this way.

1. A bipolar plate (20), comprising a plate (21) which comprises an electrically conductive plastics composite material and is structured on at least one side (22), wherein the plate (21) is coated with a catalyst (23) on the at least one structured side (22).

2. The bipolar plate (20) according to claim 1, wherein the plastics composite material contains graphite and/or at least one metal and at least one thermoplastic.

3. The bipolar plate (20) according to claim 1, wherein the catalyst (23) comprises metal particles with a number-average particle size in a range from 10 μm to 30 μm.

4. A method of producing a bipolar plate (20) according to claim 1, comprising the following steps:
providing (31) a plate (21) comprising an electrically conductive plastics composite material,
heating (32) the plate (21) to a first temperature (T₁),
heating (33) a catalyst in powder form (23) to a second temperature (T₂) which is higher than the first temperature (T₁), and
applying the catalyst (23) to a structured side (22) of the plate (21).

5. The method according to claim 4, wherein the first temperature (T₁) corresponds to at least one Vicat softening temperature of a plastic of the plastics composite material and the second temperature (T₂) corresponds to at least one dimensional stability temperature of the plastic of the plastics composite material.

6. The method according to claim 4, wherein the catalyst (23) is blown (34) onto the structured side (22) of the plate (21).

7. The method according to claim 4, wherein the catalyst (23) is applied (41) to a carrier film, is heated (33) to the second temperature (T₂) on the carrier film, the carrier film is pressed (42) onto the structured side (22) of the plate (21) and the carrier film is then removed (43) from the plate (21).

8. The method according to claim 4, wherein the plate (21) is provided (31) by being produced from the plastics composite material by injection molding or by embossing.

9. An electrolyser (10), comprising at least one bipolar plate (20) according to claim 1.
